(19) United States
(12) Patent Application Publication
(10) Pub. No.: US 2021/0139680 A1
(43) Pub. Date: May 13, 2021

(54) FILM WITH SELECTIVE OPACITY CONTRAST

(71) Applicant: The Procter & Gamble Company, Cincinnati, OH (US)

(72) Inventors: Zhan Cheng, Beijing (CN); Lei Zhou, Beijing (CN); Shuo Song, Beijing (CN); Ruizhi Pei, Beijing (CN)

(21) Appl. No.: 17/149,771

(22) Filed: Jan. 15, 2021

Related U.S. Application Data
(63) Continuation of application No. PCT/CN2018/115862, filed on Nov. 16, 2018.

(51) Int. Cl. C08L 23/06; C08L 77/02; C08K 3/26; B32B 27/32; B32B 27/08; B32B 27/20

(52) U.S. Cl. CPC C08L 23/06; B29C 43/24; C08K 3/26; B32B 27/32; B32B 27/08; B32B 27/20; C08K 2003/265; B32B 2250/02; B32B 2250/242; B32B 2307/41; B32B 2307/412; B32B 2307/414; B32B 2439/70; B32B 2439/80; C08L 77/02

(57) ABSTRACT

A thermoplastic film with a selective opacity contrast is provided, i.e., the thermoplastic film has selective areas with different opacities. Particularly, the opacity contrast is caused by a simple heating/pressure treatment on a selected portion of a voids-containing thermoplastic film. Additionally, a product packaging with a transparent or translucent window is provided so that products contained therein are visible through the window.

### FIELD OF THE INVENTION

The present application is directed to flexible thermoplastic films, wherein the films have selective areas of different opacities.

### BACKGROUND OF THE INVENTION

Flexible thermoplastic films are used in a variety of applications including the construction of packaging and containers, protective films and coatings, and even wall paper. Typical thermoplastic materials which are useful in preparing thermoplastic films include polyamide (PA), polyethylene (PE), polyethylene terephthalate (PET), polymethyl methacrylate (PMMA), polypropylene (PP), polyurethane (PU), polyvinyl acetate (PVA), and polyvinyl chloride (PVC). In turn, PE is a thermoplastic material that can be found in different grades including high-density polyethylene (HDPE), medium-density polyethylene (MDPE), linear low-density polyethylene (LLDPE), and low-density polyethylene (LDPE). Films can be blown or cast, and optionally, are subsequently stretched. Films may have one or more layers.

Selective opacity contrast (i.e., designed areas with visible optical appearance differences) and particularly the use of “windows” (i.e., transparent or translucent areas) in products or product packaging are desirable and may provide many beneficial effects. The beneficial effects may be primarily aesthetic in nature, such as providing graphics or decorations, so the product packaging is visually appealing to the users. Further, the beneficial effects can be functional in nature, e.g., by providing users with informative messages or allowing the users to see through the product packaging. For example, a secondary packaging containing a plurality of products may have a transparent window to allow the user to see how many products are available for use. Such window is in juxtaposition to a white or otherwise opaque backdrop. One way of providing such selective opacity contrast (for example, windows) is through printing. Relatively transparent thermoplastic (for example, PE) film can be printed so the printed portion is opaque while the non-printed areas remain transparent or translucent, which can then act as windows, so the user can see through the film. However, this approach is expensive, because the printing ink itself is expensive and much more ink amount is required for achieving the desired degree of opacity than for traditional graphic printing.

Accordingly, there is a need to provide a thermoplastic film with selective opacity contrast (e.g., transparent or translucent windows in an opaque background) in a more cost-effective manner, especially without the use of ink.

### SUMMARY OF THE INVENTION

The present disclosure meets one or more of the above-mentioned needs based on the surprising discovery that a simple heating/pressure treatment that is selectively applied on one or more certain portions of a voids-containing film can provide a sufficiently high opacity contrast (i.e., having both one or more high-opacity areas and one or more low-opacity areas) in a cost-effective manner, in which the untreated film has a relatively high opacity caused by presence of voids therein. Without wishing to be bound by any theory, it is believed that the treatment with heat/pressure at least partially eliminates the voids that contributes to the opacity, so that the opacity is selectively reduced in the treated portion(s).

The present disclosure provides an advantage that films with selective opacity contrast may be achieved in an opaque film by a simple heating and pressure treatment. Particularly, it provides a transparent or translucent window in a pre-determined location surrounded by the rest of the film which remains opaque.

The present disclosure also provides an advantage that an arbitrary pattern or decorative design with a certain opacity contrast may be achieved in a film by a cost-effective approach (i.e., a simple heating and pressure treatment), without printing which cannot provide sufficient opacity contrast or is more significantly expensive.

One aspect of the present disclosure provides a thermoplastic film, comprising at least a layer that comprises: a) a first portion having a first Void Area Percentage and a first Absolute Opacity Value; and b) a second portion having a second Void Area Percentage and a second Absolute Opacity Value, in which the second portion is adjacent to the first portion, wherein the ratio between the first Void Area Percentage and the second Void Area Percentage may be at least about 1.05 in which Void Area Percentage is measured by the Method for Voids Characterization, and the difference between the first Absolute Opacity Value and the second Absolute Opacity Value may be at least about 5% in which Absolute Opacity Value is measured by the IS06504-3 method. Particularly, the ratio of the first Void Area Percentage over the second Void Area Percentage may be at least about 1.05 in which Void Area Percentage is measured by the Method for Voids Characterization, and the first Absolute Opacity Value may be at least about 5% higher than the second Absolute Opacity Value in which Absolute Opacity Value is measured by the ISO6504-3 method. Particularly, the layer may comprise at least about 20% by weight of the layer of a thermoplastic material, preferably the thermoplastic material may be selected from the group consisting of PA, PE, PET, PMMA, PU, PVA, PVC, and any combinations thereof.

Preferably, in the thermoplastic film according to the present disclosure, the ratio between the first Void Area Percentage and the second Void Area Percentage may be at least about 1.1, preferably at least about 1.2, more preferably at least about 1.3, yet more preferably at least about 1.5, yet more preferably at least about 2, yet more preferably at least about 2.5, most preferably at least about 3, and/or the difference between the first Absolute Opacity Value and the second Absolute Opacity Value may be at least about 10%, preferably at least about 15%, more preferably at least about 20%, yet more preferably at least about 25%, yet more preferably at least about 30%, yet more preferably at least about 40%, most preferably at least about 50%.

Preferably, in the thermoplastic film according to the present disclosure, the ratio between the first Void Area Percentage and the second Void Area Percentage may be from about 1.05 to about 100000, preferably from about 1.1 to about 1000, more preferably from about 1.2 to about 10, yet more preferably from about 1.3 to about 5, and most preferably from about 2 to about 4;

and/or the difference between the first Absolute Opacity Value and the second Absolute Opacity Value may be from about 5% to about 95%, preferably from about 10% to about 90%, more preferably from about 15% to about 80%, yet more preferably from about 20% to about 75%, and most preferably from about 40% to about 70%.

Preferably, in the thermoplastic film according to the present disclosure, the ratio of the first Void Area Percentage over the second Void Area Percentage may be at least about 1.1, preferably at least about 1.2, more preferably at least about 1.3, and/or the first Absolute Opacity Value may be at least about 10%, preferably at least about 15%, more preferably at least about 20% higher than the second Absolute Opacity Value.

Preferably, in the thermoplastic film according to the present disclosure, the ratio of the first Void Area Percentage over the second Void Area Percentage may be from about 1.05 to about 100000, preferably from about 1.1 to about 1000, more preferably from about 1.2 to about 10, yet more preferably from about 1.3 to about 5, and most preferably from about 2 to about 4; and/or the first Absolute Opacity Value may be from about 5% to about 95%, preferably from about 10% to about 90%, more preferably from about 15% to about 80%, yet more preferably from about 20% to about 75%, and most preferably from about 40% to about 70%.

Particularly, the first Void Area Percentage may be from about 15% to about 70%, preferably from about 16% to about 30%, more preferably from about 17% to about 25%; and/or the first Absolute Opacity Value may be from about 50% to about 99%, preferably from about 60% to about 98%, more preferably from about 70% to about 90%; and/or the second Void Area Percentage may be from about 0.01% to about 15%, preferably from about 0.1% to about 14%, more preferably from about 1% to about 10%; and/or the second Absolute Opacity Value may be from about 1% to about 65%, preferably from about 5% to about 50%, more preferably from about 10% to about 40%.

Particularly, the first portion has a first Area Weighted Void Diameter of from 350 nm to 8000 nm, preferably from 400 nm to 5000 nm, more preferably from 500 nm to 2000 nm in which Area Weighted Void Diameter is measured by the Method for Voids Characterization; and/or the second portion has a second Area Weighted Void Diameter of from 8 nm to 350 nm, preferably from 10 nm to 320 nm, more preferably from 20 nm to 300 nm in which Area Weighted Void Diameter is measured by the Method for Voids Characterization.

Particularly, the layer may comprise a heat-sealed region, wherein the second portion may comprise at least one section that is not in the heat-sealed region. Particularly, the heat-sealed region may be where the film comprising this layer is bonded with another film or the other end of the same film. The heat-sealed region may at least partially overlap with the first portion, and/or the heat-sealed region may at least partially overlap with the second portion. Alternatively, the layer may be free of any heat-sealed regions.

The term “heat-sealed region” as used herein refers to a region treated by a heat sealing process that is to seal one thermoplastic to another thermoplastic using heat and pressure.

Preferably, the at least one layer of the film may further comprise: a third portion having a third Void Area Percentage and a third Absolute Opacity Value, in which the third portion is adjacent to the second portion, wherein the ratio between the third Void Area Percentage and the second Void Area Percentage may be from about 1.05 to about 100000, preferably from about 1.1 to about 1000, more preferably from about 1.2 to about 10, yet more preferably from about 1.3 to about 5, and most preferably from about 2 to about 4, in which Void Area Percentage is measured by the Method for Voids Characterization, and the difference between the third Absolute Opacity Value and the second Absolute Opacity Value may be from about 5% to about 95%, preferably from about 10% to about 90%, more preferably from about 15% to about 80%, yet more preferably from about 20% to about 75%, and most preferably from about 40% to about 70%, in which Absolute Opacity Value is measured by the ISO6504-3 method; and optionally, a fourth portion having a fourth Void Area Percentage and a fourth Absolute Opacity Value, in which the fourth portion is adjacent to the third portion, wherein the ratio between the third Void Area Percentage and the fourth Void Area Percentage may be from about 1.05 to about 100000, preferably from about 1.1 to about 1000, more preferably from about 1.2 to about 10, yet more preferably from about 1.3 to about 5, and most preferably from about 2 to about 4, in which Void Area Percentage is measured by the Method for Voids Characterization, and the difference between the third Absolute Opacity Value and the fourth Absolute Opacity Value may be from about 5% to about 95%, preferably from about 10% to about 90%, more preferably from about 15% to about 80%, yet more preferably from about 20% to about 75%, and most preferably from about 40% to about 70%, in which Absolute Opacity Value is measured by the ISO6504-3 method.

Preferably, the at least one layer of the film may further comprise: a third portion having a third Void Area Percentage and a third Absolute Opacity Value, in which the third portion is adjacent to the second portion, wherein the ratio of the third Void Area Percentage over the second Void Area Percentage is from about 1.05 to about 100000, preferably from about 1.1 to about 1000, more preferably from about 1.2 to about 10, yet more preferably from about 1.3 to about 5, and most preferably from about 2 to about 4; and/or the third Absolute Opacity Value is from about 5% to about 95%, preferably from about 10% to about 90%, more preferably from about 15% to about 80%, yet more preferably from about 20% to about 75%, and most preferably from about 40% to about 70% higher than the second Absolute Opacity Value; and optionally, a fourth portion having a fourth Void Area Percentage and a fourth Absolute Opacity Value, in which the fourth portion is adjacent to the third portion, wherein the ratio of the third Void Area Percentage over the fourth Void Area Percentage is from about 1.05 to about 100000, preferably from about 1.1 to about 1000, more preferably from about 1.2 to about 10, yet more preferably from about 1.3 to about 5, and most preferably from about 2 to about 4; and/or the third Absolute Opacity Value is from about 5% to about 95%, preferably from about 10% to about 90%, more preferably from about 15% to about 80%, yet more preferably from about 20% to about 75%, and most preferably from about 40% to about 70% higher than the fourth Absolute Opacity Value.

Particularly, the film further may comprise an additional layer which is bonded to the layer on either side of the layer, wherein the additional layer may comprise at least 20%, by weight of the additional layer, of a thermoplastic material selected from the group consisting of PA, PE, PET, PMMA, PP, PU, PVA, PVC, and any combinations thereof. Preferably, the additional layer may be transparent or translucent.

More particularly, the first portion may be opaque and/or the first Absolute Opacity Value may be at least 70%, and optionally, the first Void Area Percentage may be at least 50%; and the second portion may be transparent or translucent and/or the second Absolute Opacity Value may be no more than 30%, and optionally, the second Void Area Percentage may be no more than 15%, wherein the layer may comprise a) from 35% to 65%, by weight of the layer, of PE; and b) from 35% to 65%, by weight of the layer, of calcium carbonate.

Another aspect of the present disclosure provides a consumer product or packaged product comprising a film of the present disclosure, preferably the consumer product or packaged product is a baby care product such as diapers, a feminine care product such as tampons and pads, a laundry detergent product, a beauty care product such as facial mask, an incontinence product, a personal health care product, a paper product such as paper towel, or a food product. Preferably, the film of the present disclosure is useful as a wrapping film for feminine care products (such as pads) or as a back sheet film for baby care products (such as diapers).

Yet another aspect of the present disclosure provides a method for preparing the thermoplastic film of the present disclosure, wherein the film comprises a first surface and a second, opposite surface, and the method comprises the step of applying heating and pressure treatment on the film using a heating-and-pressing device that comprises a first module contacting the first surface of the film and a second module contacting the second surface of the film, in which the heating-and-pressing device applies a pressure of from 0.1 N/mm² to 5 N/mm² for a duration of from 0.1 seconds to 10 seconds and at least one of the first module and the second module has a contacting temperature within a range of from 80° C. to 250° C., preferably from about 120° C. to about 200° C., more preferably from about 130° C. to 180° C., and most preferably from about 145° C. to about 170° C. Preferably, the first module has a contacting temperature of from about 80° C. to about 250° C., preferably from about 120° C. to about 200° C., more preferably from about 130° C. to about 180° C., most preferably from about 145° C. to about 170° C., and the second module has a contacting temperature of from about 15° C. to about 80° C., preferably from about 20° C. to about 60° C., more preferably from about 22° C. to about 50° C., and most preferably from about 25° C. to about 40° C., and/or the pressure applied by the heating-and-pressing device may be from about 0.3 N/mm² to about 5 N/mm², preferably from about 1 N/mm² to about 4.5 N/mm², more preferably from about 1.3 N/mm² to about 4 N/mm², and most preferably from about 2 N/mm² to about 3 N/mm², and/or the duration for pressing is from about 0.2 seconds to about 5 seconds, preferably from about 0.3 seconds to about 4 seconds, more preferably from about 0.5 seconds to about 3 seconds, and most preferably from about 1 second to about 2.5 seconds.

Particularly, the heating-and-pressing device is a machine press or a calender roll. More particularly, the heating-and-pressing device is a machine press comprising plates or a calender roll comprising rollers, in which the heating-and-pressing device comprises a first heating module (for example, a first plate or a first roller) contacting the first surface of the film, and a second heating module (for example, a second plate or a second roller) contacting the second surface of the film. In some instances, the step of applying heating and pressure treatment on the film is carried out using a machine press (for example, a hydraulic press). In some other instances, the step of applying heating and pressure treatment on the film is carried out using a calender roll.

Unexpectedly, the present disclosure provides an advantage that the heat/pressure treatment in the present disclosure is very suitable for large-scale production. In other words, the present inventors surprisingly found that a high opacity contrast might be achieved using a heat/pressure treatment which can be easily scaled-up.

It is an advantage of the film according to the present disclosure that the film may provide selective opacity contrast in a cost-effective manner.

It is an advantage of the film according to the present disclosure that the heat/pressure treatment may be a one-step treatment.

It is an advantage of the film according to the present disclosure that the heat/pressure treatment may be completed within a very short time.

It is an advantage of the film according to the present disclosure that the heat/pressure treatment may be carried out under relatively mild conditions (for example, relatively low temperature and pressure) using a simple apparatus.

It is an advantage of the film according to the present disclosure that the film may provide improved opacity, as compared to printing alone, in those applications where such improved opacity is needed.

It is an advantage of the film according to the present disclosure that the film may provide additional aesthetics to the film, including but not limited to pearlescent or metallic-like visual effects.

It is an advantage of the film according to the present disclosure that the film may provide ease for recycling.

These and other features, aspects and advantages of specific embodiments will become evident to those skilled in the art from a reading of the present disclosure.

### BRIEF DESCRIPTION OF THE DRAWINGS

The embodiments set forth in the drawings are illustrative in nature and not intended to limit the invention defined by the claims. The following detailed description of the illustrative embodiments can be understood when read in conjunction with the following drawings, and in which:

FIG. 1 illustrates a thermoplastic film comprising a layer that comprises a first, more opaque portion and a second, less opaque portion, according to one embodiment of the present invention.

FIG. 2 illustrates a thermoplastic film comprising a layer that comprises a first, more opaque portion, a second, less opaque portion, a third, more opaque portion, and a fourth, less opaque portion, according to one embodiment of the present invention.

FIG. 3 illustrates a thermoplastic film comprising a layer that comprises a first, more opaque portion and a second, less opaque portion, in which the second portion comprises a heat-sealed region, according to one embodiment of the present invention.

FIG. 4 illustrates a thermoplastic comprising a first layer containing portions of different opacities and a second layer underneath the first layer, according to one embodiment of the present invention.

FIG. 5 illustrates a packed product comprising an outer package made of a thermoplastic film with a transparent window, according to one embodiment of the present invention.

FIG. 6 illustrates a process of preparing samples for the Scanning Electron Microscopy (SEM) measurements.

FIG. 7 shows the relative opacity of PE-based films (Examples 1, 5 and 8) according to the present disclosure, before and after the heating/pressure treatment, in which the cross-sections of films analyzed by SEM are located within the dashed line rectangles. The dashed line rectangles for Examples 5 and 8 indicate the treated portions of the film.

FIGS. 8A-8C are SEM images showing voids in the PE-based films according to the present disclosure in a cross-section along the machine direction before and after the heating/pressure treatment, in which A-C panels are Example 1 (before the treatment), Example 5 (after the treatment of 160° C./2.7 N/mm²/2 s), and Example 8 (after the treatment of 135° C./2.0 N/mm²/1.5 s), respectively.

### DETAILED DESCRIPTION OF THE INVENTION

The following text sets forth a broad description of numerous different embodiments of the present disclosure. The description is to be construed as exemplary only and does not describe every possible embodiment since describing every possible embodiment would be impractical, if not impossible. It will be understood that any feature, characteristic, component, composition, ingredient, product, step or methodology described herein can be combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims. All publications and patents cited herein are incorporated herein by reference.

The present disclosure is directed to a film with selective opacity contrast. Particularly, the present disclosure provides a film comprising selective portions having different opacities. FIG. 1-4 illustrates embodiments of thermoplastic films according to the present disclosure.

FIG. 1 illustrates a thermoplastic film 1 comprising a layer 10 that comprises a first portion 11 having a relatively high opacity and a second portion 13 having a relatively low opacity which is adjacent to the first portion 11.

FIG. 2 illustrates a thermoplastic film 2 comprising a layer 20 that comprises a first portion 21 having a relatively high opacity, a second portion 23 having a relatively low opacity which is adjacent to the first portion 21, a third portion 25 having a relatively high opacity which is adjacent to the second portion 23, and a fourth portion 27 having a relatively low opacity which is adjacent to the third portion 25.

FIG. 3 illustrates a thermoplastic film 3 comprising a layer 30 that comprises a first portion 31 having a relatively high opacity and a second portion 33 having a relatively low opacity which is adjacent to the first portion 31. The second portion 33 comprises a first section 331 and a second section 332 which is adjacent to the first section 331, wherein the second section 332 is a heat-sealed region.

FIG. 4 illustrates a thermoplastic film 4 comprising a first layer 40 and a second layer 42 that is underneath the first layer 40, wherein the first layer 40 comprises a first portion 41 having a relatively high opacity and a second portion 43 having a relatively low opacity which is adjacent to the first portion 41.

### Film

In the context of the present disclosure, the term “film” refers to a thin, continuous membrane, and it is used broadly to include those films having at least one, two, three, four or more layers. For example, a two-layer co-extrusion film may have a first layer according to the present disclosure described herein and a second layer that is a conventional one. Particularly, the film is a thermoplastic film which comprises a thermoplastic material.

The films of the present disclosure may be extruded or casted, preferably are uniaxially oriented, and more preferably uniaxially oriented in the machine direction. Preferably the film is a flexible film. In multi-layer films of the present disclosure, at least one layer may be the layer according to the present disclosure, and other layers of the film may be conventional layers that contain PP, PET, ethylene vinyl alcohol (EVOH), or any combinations thereof. Furthermore, the term “film” is intended to include a laminate which may be formed by heat, pressure, welding and/or adhesives. Particularly, the layers of the laminate are adhesively attached to each other by known techniques including solvent or solvent-less lamination approaches.

Optionally, the film in the present disclosure may or may not comprise a printed area, for example in a selected portion of the film.

Particularly, the thermoplastic film according to the present disclosure or the layer of the thermoplastic film according to the present disclosure may have a thickness of from 10 microns to 200 microns, preferably from 12 microns to 120 microns, more preferably from 14 microns to 100 microns, more preferably from 16 microns to 80 microns, and most preferably from 20 microns to 40 microns. Particularly, the thickness of films is a caliper thickness as measured according to ASTM D5947:18 (Standard Test Methods for Physical Dimensions of Solid Plastics Specimens).

The terms of “portion”, “region”, and “section” as used herein refer to a part of a film. Preferably, portions, regions, and/or sections in the film of the present disclosure extend throughout the whole thickness of the film according to the present disclosure or the whole thickness of the respective layer in such film according to the present disclosure.

Particularly, the film of the present disclosure comprises a first surface and a second, opposite surface. More particularly, the first surface is an upper surface and the second surface is a lower surface.

Particularly, the film of the present disclosure may be a single-layer film. Alternatively, the film of the present disclosure may be a multiple-layer film comprising at least a continuous layer that comprises a first portion with a relatively high opacity and a second portion with a relatively low opacity.

### Thermoplastic Material

The thermoplastic film containing voids in the context of the present disclosure may contain one or more thermoplastic materials (for example thermoplastic polymer) which may be selected from a group consisting of various materials, for example PA, PE, PET, PMMA, PP, PU, PVA, PVC, and any combinations thereof.

The term “thermoplastic material” as used herein refers to a material that becomes pliable or moldable above a specific temperature and solidifies upon cooling.

A typical thermoplastic material which may be useful in the present disclosure is PE. At least one layer of the films of the present disclosure may comprise PE as a principal thermoplastic material (i.e., a PE-based film), and alternatively, at least one layer of the film comprises a PE component, but not as a principal material (i.e., a PE-containing film). In turn, the PE component may comprise one or more different types (or even sub-types) of PE polymers. PE is generally divided into high-density PE (i.e., HDPE with a density of about 0.941 g/cc or greater), medium-density PE (i.e., MDPE with a density of from about 0.926 to about 0.940 g/cc), low-density PE (i.e., LDPE with a density of from about 0.910 to about 0.925 g/cc), and linear low-density PE (i.e., LLDPE with a density of from about 0.910 to about 0.925 g/cc). See e.g., ASTM D4976-98: Standard Specification for Polyethylene Plastic Molding and Extrusion Materials. In turn, these PE types can be further divided into mono-modal or multi-modal (e.g., bi-modal) sub-types. The molecular weight of PE may be from 20,000 to 8,000,000 Da, preferably 40,000 to 500,000 Da, and more preferably 50,000 to 200,000 Da, for example, from 100,000 to 500,000 Da, from 50,000 to 200,000 Da, from 40,000 to 300,000 Da.

The key physical properties of PE-based film layer may include tear strength, impact strength, tensile strength, stiffness, and transparency. Different combinations of PE types, and sub-types may be used herein depending upon the specific applications and/or desired properties. Preferably, the PE component of the present disclosure, comprises LLDPE. Suitable suppliers/products for PE may include Dowlex™ from Dow Chemical (such as 2006G, 2035G, 2036.01G, 2042G, 2045.01, 2645G and the like) and Borstar™ from Borealis and Borouge (such as FB2230, FB2310, FB1350 and the like).

Particularly, at least one layer of the film may comprise from about 20% to about 99%, by weight of the at least one layer, of a PE component. Particularly, the at least one layer of the film may comprise from about 30% to about 99%, preferably from about 40% to about 99%, more preferably from about 50% to about 98%, most preferably from about 75% to about 98%, for example 20%, 25%, 30%, 35%, 40%, 45%, 50%, 55%, 60%, 65%, 70%, 75%, 80%, 85%, 90% or any ranges therebetween, by weight of the at least one layer, of the PE component. The PE component may include at least one type of PE polymer, optionally two or more different types of PE polymers.

Preferably, the at least one layer comprises from about 1% to about 100% by weight of the PE component, of a LLDPE polymer. More preferably the LLDPE is present in an amount ranging from about 25% to about 100%, preferably from about 30% to about 90%, yet more preferably from about 40% to about 80%, yet more preferably from about 50% to about 70%, by weight of the PE component.

Another typical thermoplastic material which may be useful in the film containing voids is PP. Particularly, at least one layer of the film may comprise PP as a principal thermoplastic component (i.e., a PP-based film), and alternatively, at least one layer of the film may comprise PP, but not as a principal thermoplastic component. In turn, the PP-based component may comprise one or more types of PP polymers.

The PP polymer may be a polypropylene homopolymer, a random PP-based copolymer or a block PP-based copolymer (for purpose of this allocation “copolymer” includes terpolymers). Particularly, a first PP polymer is selected from the group consisting of a random propylene-olefin copolymer, a block propylene-olefin copolymer, and combinations thereof. Preferably, the first PP polymer is selected from the group consisting of a random propylene-α-olefin copolymer, a block propylene-α-olefin copolymer, and combinations thereof; and more preferably wherein the α-olefin is selected from the group consisting of ethylene, 1-butene, 1-hexene, and combinations thereof. Suitable suppliers/products for PP may include Sinopec Chemicals, LBI, and Borealis.

The PP-based component may further comprise a second polypropylene polymer, wherein preferably, the second polypropylene polymer may be present in an amount of from about 1% to about 90%, preferably from about 5% to about 80%, more preferably from about 10% to about 70%, yet more preferably from about 12% to about 60%, yet more preferably from about 15% to about 45%, by weight of the PP-based component.

Particularly, at least one layer of the film may comprise from about 20% to about 99%, by weight of the at least one layer, of a PP component. More particularly, the at least one layer of the film comprises from about 30% to about 98%, preferably from about 40% to about 97%, more preferably from about 50% to about 96%, most preferably about 60% to about 95%, yet more preferably from 70% to about 90%, by weight of the at least one layer, of the PP component.

### Voids

Without wishing to be bound by any theory, voids in the film of the present disclosure create interfaces which interact with incident light, and this interaction with light contributes to the overall opacity of the film.

The term “void” or “voids” as used herein is intended to mean cavities or bubbles formed in a film (for example, a PE-based film of the present disclosure). Voids in the film of the present disclosure may be formed by different ways, for example, foaming (including physical foaming and chemical foaming), phase separation between immiscible blends, and the like. The voids may have different shapes, sizes, concentrations and orientations.

In the context of the present disclosure, the expression of “substantially free of voids” means that the Void Area Percentage of a film as measured by the Method for Voids Characterization is no more than about 8%, no more than about 7%, no more than about 6%, no more than about 5%, no more than about 4%, no more than about 3%, no more than about 2%, no more than about 1%, or no more than about 0.5%.

### Void Formation

One way to create the voids in the film as mentioned hereinabove is through an activation process (for example, stretching during machine direction orientation) in which void initiators are activated to mechanically cavitate the film and provide voids. These voids act as light scattering loci to opacify the film. The activation process normally involves mechanical stretching. Typical processes include machine direction activation, bi-axial orientation, ring rolling, or embossing or other solid-state formation processes involving mechanical stretching. Without wishing to be bound by any theory, it is believed that during machine direction activation or bi-axial orientation, the stretching results in phase separation in the interface between the void initiator and the thermoplastic matrix (such as PE), thereby forming voids around the void initiator particles. These voids are typically elongated along the stretched direction, e.g. voids from machine direction (MD) orientation direction and have a propagating effect along the MD. This effect goes across the thickness of the film to create yet more voids and greater separation between the initiator and the thermoplastic material, and as a result, more interface for light scattering leads to the opacified film. Person skilled in the art should have a good knowledge of the void initiator materials and the processes to provide voids via activation.

Another way to create voids in film is through a foaming process. The foaming process can be either a physical or a chemical process. Physical foaming is carried out by injecting gas into molten thermoplastics to form a super-critical melt. The super-critical thermoplastic melt is then extruded through an extrusion die to form a film. Upon extrusion from the die, sudden drop of pressure allows the gas to expand or release from the thermoplastic melts, thereby forming voids in the extruded thermoplastic film. The typical gas used for physical foaming is N₂, but other gas such as CO₂, He, or even air can also be used. Chemical foaming is carried out by adding materials (i.e., foaming agents) which decompose into gas at a certain range of temperature. The foaming agents are typically blended with thermoplastic material before extrusion. Typical material used for chemical foaming includes sodium bicarbonate (NaHCO₃), ammonium carbonate (NH₄)₂CO₃, azoformamide (C₂H₄N₄O₂), azodiisobutyronitrile (C₈H₁₂N₄), and citric acid derivates

Commercially available forms of such void-containing PE film include breathable film which is widely used in consumer products such as baby diaper, feminine pad, and environmental regulatory packages for fresh food, such as vegetable and fruits. Suitable breathable film includes HyCare®, Hyfol®, and HyLite® from RKW, HIPORE™ from Asahi Kasei Corp. and the like.

### Master Batch

In an exemplary way, a master batch comprising a thermoplastic material (for example PE) and a void initiator is prepared in order to create voids in the film. Optionally, silicone additive and/or compatibilizer may be added. Typically, the master batch may comprise from 50% to 95%, preferably 60% to 90% of a thermoplastic material, by weight of the master batch, of a thermoplastic material. The master batch may typically comprise from 5% to 50%, preferably from 10% to 30%, more preferably from 15% to 25%, by weight of the master batch, of a void initiator.

In an exemplary process for PE, the master batch may be prepared by heat extruding a first batch of PE pellets with a first heat extruder, either single or double screw, wherein the void initiator and/or compatibilizer are added at one or more ports along the extruder. Typical operating temperatures for the first heat extruder are from 180° to 250° Celsius (C), preferably 190° to 230° C. Preferably, the maximum heating temperature of the first heat extruder is at the lower range than that recommended as the processing temperature for void initiator pellets, as void initiator typically has a higher process temperature than PE pellets. For purposes of clarification, the term “pellets” means smaller sized nuggets, pastilles, or the like to allow for efficient melting and/or extrusion and/or blending.

An exemplary process for foaming master batch is the same with the above-mentioned process for void initiator master batch except the process temperature setting. The process temperature for master batch should be kept below the starting temperature to prevent the additive from decomposing during master batch making process. An example of foaming master batch is Hydrocerol® from Clariant.

### Void Initiator

In the context of the present disclosure, the term of “void initiator” is intended to mean a material capable of creating voids in a thermoplastic film under a particular condition, and these terms may be interchangeably used.

Preferably, the void initiator which may be useful in the present disclosure is an inorganic material with a refractive index of less than 2, preferably less than 1.9, more preferably less than 1.8, most preferably less than 1.7, according to ASTM D-542. The void initiator may also be an organic material which is immiscible with the thermoplastic material.

Preferably, a layer of a film of the present disclosure may comprise from about 1% to about 80%, by weight of the layer of the film, of a void initiator. Preferably, the layer comprises from 2% to 70%, preferably from 3% to 60%, more preferably from 4% to 55%, most preferably from 5% to 50%, by weight of the layer, of the void initiator.

The term “refractive index” used herein is a dimensionless number that describes how light propagates through that medium. It is defined as n=c/v, where c is the speed of light in vacuum and v is the phase velocity of light in the medium.

Particularly, the inorganic material suitable for use as the void initiator in the present invention is selected from the group consisting of BaSO₄, SiO₂, CaSiO₃, Al₂O₃, CaCO₃, lithopone, Al₄[Si₄O₁₀][OH]₈ and any combinations thereof. Preferably, the inorganic material is selected from the group consisting of BaSO₄, SiO₂, CaCO₃, and any combinations thereof.

Particularly, the organic material suitable for use as the void initiator in the present invention is selected from the group consisting of PA, PET, PMMA, PS, PP, PE, PU, PVA, PVC and any combinations thereof. Preferably, the organic material is selected from the group consisting of PA, PET, PMMA, and any combinations thereof.

Preferably, the void initiator is selected from the group consisting of CaCO₃, PA, PMMA and a combination thereof.

More particularly, the at least one layer of the film comprises: a) from 20% to 99%, preferably from 30% to 98%, more preferably from 35% to 65% by weight of the layer, of the thermoplastic material, which is preferably PE; and b) from 1% to 80%, preferably from 2% to 70%, more preferably from 35% to 65% by weight of the layer, of the void initiator, which is preferably calcium carbonate and/or PMMA.

Particularly, calcium carbonate is a preferred void initiator. Preferably, a layer of a film of the present disclosure may comprise from about 1% to about 80%, by weight of the layer, of a calcium carbonate component. The calcium carbonate component is incorporated into the thermoplastic component (such as PE) before extrusion or casting of the thermoplastic component (such as PE) into films. Preferably, the layer comprises from 1% to 99%, preferably from 20% to 80%, more preferably from 35% to 65%, most preferably from 45% to 55%, by weight of the layer, of the calcium carbonate component.

Particularly, PA (for example, Nylon 6, Nylon 66, Nylon 11 or Nylon 12) is a preferred void initiator. Preferably, a layer of a film of the present disclosure may comprise from about 1% to about 80%, by weight of the layer of the film, of PA component. The PA component is incorporated into the thermoplastic component (such as PP) before extrusion or casting of the thermoplastic component (such as PP) into films. Preferably, the layer comprises from 1% to 99%, preferably from 10% to 50%, more preferably from 15% to 45%, most preferably from 20% to 40%, by weight of the layer, of the PA component.

Particularly, PMMA is a preferred void initiator. Preferably, a layer of a film of the present disclosure may comprise from about 1% to about 50%, by weight of the layer of the film, of a PMMA component. In turn, the PMMA component may comprise one or more types (or even sub-types) of a PMMA polymer. The PMMA component is incorporated into the thermoplastic component (such as PE) (within at least one layer of the film) before extrusion or casting of the thermoplastic component into films. Preferably, the layer comprises from 1% to 99%, preferably from 2% to 40%, more preferably from 3% to 30%, most preferably from 5% to 20%, by weight of the layer, of the PMMA component. The PMMA component has at least one PMMA polymer, optionally two more different types of PMMA polymers.

### Extrusion

After the master batch is prepared, it may be directly used for extrusion. Alternatively, the master batch may be combined with a thermoplastic material (such as PE pellets) in a desired weight ratio. The thermoplastic materials may or may not be the same composition as the first batch of thermoplastic materials (as detailed above in master batch preparation). A typical percentage of master batch by weight of the composition is from 5% to 70%. The combination of master batch and thermoplastic materials may be subjected to a blending step prior to extrusion to provide a blend.

The resulting blend may be extruded through a second heated extruder, either single or twin screw, preferably through an extruder having a temperature gradient to form an extrudate. Initial temperatures of the second heated extruder, for example, may be at 200° C. incrementally increased downstream to a final temperature of 250° C. Temperatures may vary depending upon the composition of the resulting blend, and so do the length and the speed of the second heated extruder. An optional step is adding yet more void initiator and optionally, silicone additive and/or compatibilizer through one or more ports of the second heated extruder to yet further increase the overall void initiator/silicone additive/compatibilizer concentration.

Alternatively, no master batch is prepared, but rather void initiator and optionally, silicone additive and/or compatibilizer are simply added via the second heated extruder with only a single batch of thermoplastic materials (such as PE pellets) extruded there through.

The extrudate is formed after being extruded through the second heated extruder. The extrudate may be then subjected to a blowing step or a casting step. The typical blowing step is to extrude the extrudate upward via a ring die to form a tube and inflate the tube while pulling it through a collapsing frame whereby the tube is enclosed with a frame and nip rollers. The blowing step can also be a water quenching process, in which the inflated tube is extruded downward through a ring die with another water ring to spray water on the tube surface to quench it. A casting step subjects the extrudate though a T-die to form a flat sheet with an air knife to push the flat sheet against a cooling roller to set the film. These steps are generally conventional. The blown and/or casted extrudate is formed into an unconverted film. The unconverted film typically has hazy appearance and it requires additional orientation process to impart the desired unique opacity.

### Film Orientation (Stretching)

The unconverted film is thereafter at least uniaxially oriented, preferably machine direction (“MD”) oriented. In some instances, the unconverted film is bi-axially oriented including MD orientation and traverse direction (TD) orientation.

The MD direction is also known as the longitudinal direction (generally perpendicular to TD). MD orientating is a preferred activation step after the unconverted film is formed. During the MD orientation, the unconverted film from the blown or casted line is heated to an orientation temperature via one or multiple hot rollers. The heated film is fed into a slow draw roll with a nip roller, which has the same rolling speed as the heating rollers. The film then enters a fast draw roll. The fast draw roll has a speed that is 2 to 10 times faster than the slow draw roll, which effectively stretches the film on a continuous basis. There can be optionally another fast draw roll which is even faster than the first fast draw roll so that the film is subjected to two-step stretching. Between the two stretching steps there is optionally another set of heating rolls which sets the temperature of the film after the first stretching and before the second stretching. The temperatures in these two stretching steps can be the same or different. The orientation can also be a single stretching instead of two-step stretching.

The total MD stretch ratio is from 2:1 to 10:1, more preferably from 3:1 to 9:1, and even more preferably from 4:1 to 6:1. The total MD stretch ratio includes all orientation steps. For example, if a two-step orientation is used with first stretch ratio 2:1 and second stretch ratio 3:1, the total stretch ratio is therefore 6:1.

The orientation temperature of the present invention, preferably in a MD orientation, may be from about 50° C. to about 110° C., preferably from 60° C. to 90° C., more preferably from 70° C. to 80° C. The temperature also depends on the process speed. In general, higher process speed requires relatively higher temperature due to the relative shorter contacting time between film and hot rollers; while slower process speed requires relatively lower temperature due to the longer contacting time. Without wishing to be bound by any theory, during orientation, the stretching results in phase separation in the interface between void initiator dispersed particles and the thermoplastic material matrix (such as PE matrix), thereby forming micro cavities around void initiator particles. These cavities are typically stretched along the MD orientation direction and have a propagating effect along the machine direction and across the thickness of the film to create yet more larger quantity/more separation of the void-initiator/thermoplastic-material interface. At a high orientation temperature, the mobility of the thermoplastic material (such as PE) amorphous phase is rather high and thus is able to fill these cavities preventing or eliminating the formation of some of these desired micro structures. In contrast, a low orientation temperature maintains the voids or cavities structure quite well. But too low an orientation temperature makes the film more difficult to be stretched due to higher stretching force, and the film tends to break or rupture as the poor mobility of PE amorphous phase can't accommodate the deformation during orientation.

Optionally, the stretched film then enters annealing thermal rollers, which allow stress relaxation by holding the film at an elevated temperature for a period of time. Annealing generally makes the film less stiff and softer to the touch, which are desired tactile effects for a film in some applications. And it may also reduce the post-MDO shrinkage. To achieve such annealing, the annealing temperature should not be below the orientation temperature, and more preferably the annealing temperature is about 5-10° C. above the orientation temperature. But in either case, the annealing temperature is generally not expected to exceed 110-120° C., because as at such temperatures, the unique aesthetic effects of the film can be harmed. As a last step, the film is cooled through cooling rollers to an ambient temperature. The resulting MD oriented film may be further subjected to either: optional surface treatment steps/optional coatings (described below); or proceed to further TD orientation. In contrast, a shrink film will preferably not have annealing or be at annealing temperature much lower than orientation temperatures.

A typical thickness of the MD oriented film, i.e., overall film, is from about 15 microns to about 80 microns, preferably from about 20 microns to about 70 microns, more preferably from about 25 microns to about 50 microns.

Commercial available converting systems may include those from Windmoller & Holscher, DUSENBERY, MARSHALL and WILLIAMS, winders may come from PARKSINSON. Drive and control systems for film making may include those from ALLEN-BRADLEY Powerflex AC drives, and ALLEN-BRADLEY ControlLogix PLC processor. A suitable manufacture may be PARKINSON TECHNOLOGIES, Inc. (Woonsocket, R.I., USA).

### Heating/Pressure to Reduce/Eliminate Voids

There may be different approaches to achieve the aforementioned selective opacity contrast in thermoplastic films. One preferred approach is heating/pressure treatment under certain conditions (e.g., heating at a certain temperature and applying a certain pressure for a certain period) to partially soften/melt the film and collapse some or all of the voids. Accordingly, the treated region of the film has a reduced opacity. Without wishing to be bound by any theory, upon application of heat at specific regions, the thermoplastic film starts to soften or melt within such regions. Further application of pressure at such regions lead to collapses or mergers of the voids within such regions. As a result, the voids are substantially reduced or completely eliminated, and the opacity in these regions is correspondingly reduced.

The important factors which impact the heating/pressure treatment process include temperature, dwell time and pressure. The temperature and dwell time basically defines how much heat can be transferred to the film.

To substantially reduce or eliminate the voids in the selective areas, sufficient heat need to be transferred so that the thermoplastic materials can be softened or melted to collapse the voids upon application of pressure. If the transferred heat is not high enough, the material is not softened or melted, so that under pressure it does not deform, and the voids therein do not collapse. As a result, the film remains opaque. In addition, under this condition the voids-containing film may shrink due to the release of the internal stress from the activation process, leaving wrinkles to the film. On the other hand, if the transferred heat is too high, the thermoplastic material may be completely melted or even decompose, leaving holes or film failures during the heat treatment process.

The pressure is also an important factor to drive voids closure. Low pressure will require more heat to collapse the voids and leaving narrow process window, while high pressure will create film failures.

Such treatment can be achieved by several ways. For example, on a lab scale, a machine press (for example, a hydraulic press) that is commonly equipped with a plate for heating/compression can be used. Using a heat-conductive plate with a designed pattern, the pattern can be replicated to the film. On a large-scale, a rotatory calendering machine (calender rollers) can be used. A typical rotatory calendering machine includes a heated metal cylinder with a desired pattern, and a nipping roller against this metal cylinder. Pressure and heat are applied on the film via the raised cylinder region so as to close the voids. Preferably, the heating-conductive plate has a lower heating jaw and an upper heating jaw. More preferably, the lower heating jaw or the nipping roller has a relatively low contacting temperature such as about 15° C. to about 80° C., for example about 20° C., about 30° C., about 40° C., about 50° C., about 60° C., about 70° C. and the like, whereas the upper heating jaw or the heated metal cylinder has a higher contacting temperature such as 100° C. to 200° C., for example, 120° C., 130° C., 140° C., 150° C., 160° C., 170° C. and the like. Alternatively, the lower and upper heating jaw or nipping rollers has the same temperature settings. The treatment time is another important variable. Typically, the treatment duration (i.e., time for pressing) is from 0.3 to 5 seconds, for example 0.5 seconds, 1 second, 1.5 seconds, 2 seconds, 2.5 seconds, 3 seconds, 3.5 seconds and the like. To achieve a required degree of reducing voids, a relatively high contacting temperature of the lower and/or the upper heating jaw may be employed with less treatment duration compared to a relatively low contacting temperature. Another variable is the pressure. Typical pressure is from about 0.3 N/mm² to about 3 N/mm², for example about 0.5 N/mm², about 0.8 N/mm², about 1 N/mm², about 1.5 N/mm², about 1.8 N/mm², about 2 N/mm², about 2.5 N/mm², about 3 N/mm², about 3.5 N/mm² or any ranges therebetween. Actual pressure/time/temperature will depend upon the film used, including thickness, layers, chemistry, size of voids, and desired level of non-opacity.

Particularly, an additional thermoplastic film may be used as a substrate during the heating/pressure treatment, wherein the sample film is positioned onto the substrate film and then they are together treated under the heating/pressure condition. More particularly, a clear PE or PP film may be useful.

As used herein, the term “machine press” means a machine tool that changes the shape of a workpiece by the application of pressure.

As used herein, the term “calender roll” means a series of hard pressure rollers used to press, finish or smooth a sheet of material such as paper, textiles, or plastics.

As used herein, the term “contacting temperature” means the temperature on the surface of the first module or the second module of the heating-and-pressing device which is contacting to the film.

### Optional Ingredients

The film of the present disclosure may contain one or more optional ingredients in addition to those described hereinabove. The film may comprise from 0.01% to 15%, preferably from 1% to 12%, more preferably from 2% to 10%, by weight of the layer, of an optional ingredient. The optional ingredient preferably comprises at least a silicone additive, alternatively comprises at least a compatibilizer, more preferably comprises a silicone additive and a compatibilizer. Additionally, the film may further comprise an opacifying enhancer. Appropriate opacifying enhancer may include titanium dioxide, CaCO₃, Carbon black, ZnO₂, BaSO₄, organic dye, and the like. Particularly, titanium dioxide is preferred where the films are desired to have a white appearance. One skilled in the art will readily identify other opacifying enhancers by selecting those materials that have a refractive index substantially different than the rest of the film layer. Particularly, where increased opacity is desirable, the present films may provide enough opacity in certain regions without expensive opacifying enhancers or at least minimizing the use of such opacifying enhancers (such as titanium dioxide (TiO₂)). Typically, the film of the present disclosure may comprise from 0 to 10%, such as 1% to 5% by weight of at least the one layer of the film, of the opacifying enhancer.

Particularly, the film of the present disclosure may further comprise no more than 1%, preferably no more than 0.5%, more preferably no more than 0.1%, yet more preferably no more than 0.05%, yet more preferably no more than 0.02%, yet more preferably no more than 0.01%, yet more preferably no more than 0.002%, most preferably no more than 0.001%, by weight of the layer, of opacifying enhancer such as TiO₂.

Silicone additive is an optional ingredient. Without wishing to be bound by any theory, it is believed that silicone additive can act not only as a lubricant, but also certain silicone additives or at relatively higher levels can enhance the visual and/or tactile effects of the films herein. The films of the present disclosure, that contain silicone additive, may comprise from 0.01% to 10% of the silicone additive by weight of the least one layer of the film, preferably from 0.5% to 8%, more preferably from 1% to 5%, yet more preferably from 1.5% to 3% by weight of the at least one layer of the film, of the silicone additive. The silicone additive can be added either via a master batch which to be blended with other ingredients during film extrusion stage; or at a film extrusion stage in which the silicone additive is directly blended with other ingredients; or a combination thereof.

The immiscibility between the void initiator and the thermoplastic material (such as PE) may lead to excessive phase separation, which is a factor for the poor mechanical properties of many films made from these conventional blends. A compatibilizer may be useful in eliminating or minimizing the above issue to improve the mechanical properties of the formed film. A useful compatibilizer is polypropylene grafted maleic anhydride (PPgMA). Another useful compatibilizer is Polyolefin grafted maleic anhydride (PO-g-MAH).

Particularly, at least one layer of the film may comprise 0.1% to 7%, preferably 0.5% to 5%, more preferably 1% to 3%, alternatively 1.5% to 2% by weight of the least one layer, of the compatibilizer.

### Use of the Film for Making Product Package

A packaged product or a packaging material that comprises the thermoplastic film of the present disclosure is also provided. The selective opacity contrast of the thermoplastic film provides aesthetic and/or functional benefits.

The term “package” or “packaging” herein is intended to mean any container that is meant to be sealed most of the time, especially before the contents are used or taken out, against environmental conditions such as air and/or moisture. The package includes rigid containers and flexible containers, and any conventional method can be used for forming packages from thermoplastics. For rigid containers such as bottles, sealable cartons, storage tanks especially for water, chemicals, fuels and solvents, cosmetic jars, barrels, and drums, the thermoplastic film of the present disclosure may be used as a shrink sleeve or a layer thereof on the rigid containers, for example shrink sleeve labels, pressure sensitive labels, films laminated with paperboard of cartons. For flexible packaging such as bags or pouches, they may be made directly from the thermoplastic film of the present disclosure (such as PE-based film), or from multi-layer films laminated via suitable approaches that contain at least one layer of the thermoplastic film of the present disclosure. A film may be folded once, heat sealed along the sides, filled, and then heat sealed at the other end, or adhesive may be used for some or all of the seals.

In some instances, an opaque package with one or more windows (i.e., a transparent or translucent portion in the opaque package) is desired, for example when consumers expect to see contents or certain parts of contents in the package or it might visual aesthetics. Such package or at least one layer of such package may be made from the thermoplastic film of the present disclosure. Particularly, one or more portions in the thermoplastic film of the present disclosure are windows, through which contents beneath the film are visible.

In some other instances, an opaque package with an aesthetical design or pattern is desired, in which the aesthetical design or pattern is established by arranging portions with different opacities in the package. Such package or at least one layer of such package may be made from the thermoplastic film of the present disclosure.

FIG. 5 illustrates a packed product 5 comprising an outer package 51 made of a thermoplastic film with a transparent window 52 for the user to view the interior of the package.

### Test Methods

### Test Method 1: Method for Voids Characterization

Void Area Percentage and Area Weighted Void Diameter are measured by the Method for Voids Characterization. To determine Void Area Percentage and Area Weighted Void Diameter for a given film, a Scanning Electron Microscopy (SEM) image of a cross-section of the film along the machine direction is captured by a SEM system and analyzed by computer. The method is as described in detail below.

a) Sample Preparation

The Leica EM TIC 3X ion mill system with the cryogenic function is used to prepare cross-sections of film samples for SEM image acquisition. The broad ion beam milling can produce a smooth and nondeformable cross-section of plastic samples by sputtering away the excess material by ion beam. And the cryogenic function eliminated the thermos-damage during milling for the thermal sensitive materials, e.g. plastics.

The film sample is prepared with a sandwich structure for ion milling, from bottom to top: 1) double face copper tape (size: ˜10 mm*5 mm, since the thermal conductivity when cryogenic function is applied); 2) a piece of PE film (PE film A, size: ˜4 mm*8 mm) on one side of copper tape; 3) sample film placed in the direction show the cross section at the machine direction (size: 6 mm*8 mm); 4) a second piece of PE film (PE film B, size: 8 mm*8 mm); and 5) a piece of aluminum tape (size: ˜10 mm*5 mm) (see FIG. 6A).

The sample film is cut at the edge in the machine direction by the blade to get a visually sharp and clean cross-section. Then stick the sandwich structured films on the sample holder of the ion mill properly. The cross-section of the sandwiched samples will be milled from the aluminum tape to the PE film B, to sample, to the PE film A and finally to the copper tape (see FIG. 6B). The parameters used for the ion mill are: Beam energy—6.0 kV; Beam current—2.2 mA; Temperature—−20° C.; Milling time—2-3 hours.

b) Image Acquisition

Scanning Electron Microscopy images are taken by a HITACHI 54800 at the milled cross-section with the following parameters: Coating: Pt, 60 seconds under 15 mA; Work Distance: 8 mm; Accelerate Voltage: 3 kV.

c) Image Analysis

The SEM image is imported into Image J 1.52e. The imported image is then binarized by adjusting the image threshold, resulting into a black and white binary image, in which voids regions is set to gray level 255 and the film matrix regions is set to gray level 0. The binary image is then further processed using the “close” module and “fill holes” module to eliminate noise.

c1) Calculation of Void Area Percentage

Void Area Percentage is determined as the ratio of the area of black regions (void) to the sum of the area of white regions (matrix) and black regions (void) by Image J 1.52e.

Void Area Percentage=(Area of Void/(Area of Void+Area of Matrix))*100%

For each sample, Void Area Percentage is the average of four corresponding values for four SEM images that are processed and analyzed following the procedure above.

c2) Calculation of Area Weighted Void Diameter

Area Weighted Void Diameter distribution is measured by calculating the thickness map through the Local Thickness module in Image J. The pixel value in the void region of the binary image is replaced with the diameter of the largest sphere that fits inside the void region. Thus, the histogram of the thickness map is a measurement of the Area Weighted Void Diameter distribution. The detail of the Local Thickness calculation can be found in “A new method for the model-independent assessment of thickness in three-dimensional images”, T. Hildebrand and P. Rüessgsegger, J. of Microscopy, 185 (1996) 67-75.

For each sample, four SEM images are processed and analyzed following the procedure above to obtain four corresponding thickness maps. The void size parameters such as D₅₀, D₉₀, median void diameter, mean void diameter, and standard deviation are extracted from merged histogram of the four calculated thickness maps. Area Weighted Void Diameter is determined as the mean void diameter as calculated above.

### Test Method 2: Method for Determining Opacity

Absolute Opacity Value and Opacity Value per Unit Thickness are determined by the method in ISO6504-3. The opacity value is shown as a percentage between 1 and 100%. A test method for measuring opacity is as described in detail below.

a) Principle

Black and while charts are covered by the film to be tested. The tristimulus values of each covered chart are measured over the black and the white areas. The contrast ratio is calculated as a percentage for each covered chart to provide an Absolute Opacity Value.

b) Apparatus

Black and white charts, all the same size and measuring at least 100 mm×200 mm, are printed and varnished to give adjacent black and white areas. For example, BYK-Gardner PA-2810 byko-charts for Opacity can be used.

The black and white areas shall have dimensions not less than 80 mm×80 mm. The tristimulus value Y of the white areas of the charts shall be 80±2 when measured over a white area using a reflectometer or spectrometer (for example, BYK 6801) for D65 standard illuminant with an accuracy of 0.3%, and that of the black area shall not be greater than 5, unless otherwise agreed.

To avoid errors due to variation from one batch of charts to another, the charts used for the test shall come from the same batch.

c) Measurement of Tristimulus Value Y

The tristimulus values of each covered chart are measured at a minimum of four positions over both the black (Y_{b}) and the white (Y_{w}) areas of each chart and then the mean tristimulus values Y_{b} and Y_{w} are calculated, respectively.

d) Calculation of Absolute Opacity Value

The Absolute Opacity Value for each tested sample is calculated by the equation: Absolute Opacity Value (%)=(Y_{b}/Y_{w})×100. Opacity Value per Unit Thickness is calculated by dividing the Absolute Opacity Value by the thickness of the tested sample.

### EXAMPLES

### A. Examples of Films Containing Voids

Examples A to N of films containing voids are provided. Examples A to C contains PP (as a thermoplastic material), Nylon 6 (as an organic void initiator), and PPgMA (as a compatibilizer). Examples D to G contains PE (as a thermoplastic material), PMMA (as an organic void initiator), and PPgMA or silicone oil (as a compatibilizer). Examples H to K contains PE (as a thermoplastic material) and CaCO₃ (as an inorganic void initiator). Examples L to N contains PE (as a thermoplastic material), CaCO₃ and PMMA (as a void initiator), and PPgMA (as a compatibilizer).

TABLE 1
Exemplary formulations of the film according to the present disclosure

| | Thermoplastic | | | | | Additional ingredients | |
|---|---|---|---|---|---|---|---|
| Example | material (wt %) | | Void initiator (wt %) | | | (wt %) | |
| No. | PE¹ | PP² | CaCO₃ | PMMA³ | Nylon 6² | PPgMA² | Silicone oil⁴ |
| A | — | 31 | — | — | 54 | 15 | — |
| B | — | 30 | — | — | 55 | 15 | — |
| C | — | 29 | — | — | 56 | 15 | — |
| D | 85 | — | — | 10 | — | — | 5 |
| E | 80 | — | — | 15 | — | — | 5 |
| F | 88.5 | — | — | 10 | — | 1.5 | — |
| G | 83.5 | — | — | 10 | — | 1.5 | 5 |
| H | 51 | — | 49 | — | — | — | — |
| I | 55 | — | 45 | — | — | — | — |
| J | 60 | — | 40 | — | — | — | — |
| K | 65 | — | 35 | — | — | — | — |
| L | 68 | — | 23.5 | 7.5 | — | 1 | — |
| M | 65 | — | 23.5 | 10.5 | — | 1 | — |
| N | 60 | — | 28.5 | 10.5 | — | 1 | — |

¹Dowlex ™ 2045G from Dow Corning in Examples D to G.
²The compounded resins of PP, Nylon6, and PPgMA are from A. Schulman Inc., Akron, Ohio, USA
³PMMA V020, Altuglas ® from Arkema.
⁴MB50-002 from Dow Corning.

Formation of Examples A to C (PP and Nylon 6)

The PP-Nylon 6 blended films A-C described as above are formed by first drying a mixture containing PP, Nylon 6, and PPgMA in a vacuum oven for 48 hours at 60° C. before extrusion, and then co-extruding using a single-screw extruder of a two-component co-extrusion system having a 1-inch diameter screw, a L/D ratio of 15 and an extrusion temperature of 255° C. The extruded film is subjected sequentially to a two-step stretching process including the traverse direction (TD) followed by the machine direction (MD) at the temperature of 155° C. to provide an oriented film containing voids. Total stretching ratio is 6.25:1, with the first stretching ratio at 2.5:1, and second stretching ratio is at 2.5:1.

Formation of Examples D to G (PE and PMMA)

The PE-based films D-G containing PMMA as the void initiator described as above are formed by first extruding a single layer film using a single-screw extruder and adding the compatibilizer of PPgMA or silicone oil during the film extrusion. The extruded film is subjected to a two-step stretching process on a pilot scale continuous orientation machine below 90° C. to provide an oriented film containing voids. Total stretching ratio is 8:1, with the first stretching ratio at 2:1, and second stretching ratio is at 4:1.

Formation of Examples H to K (PE and CaCO₃)

The PE-based films H to K containing CaCO₃ as the void initiator described as above are formed by first forming a blown single layer film using a single-screw extruder. The extruded film is subjected to a one-step stretching process on a commercial scale machine direction orientation machine below 90° C. to provide an oriented film containing voids. The stretching ratio is 4:1.

Formation of Examples L to N (PE and CaCO₃/PMMA)

The PE-based films L to N containing CaCO₃/PMMA as the void initiator described as above are formed by first forming a blown multilayer film co-extruded using single-screw extruders of a co-extrusion system. CaCO3 and PMMA may be added in one or more layers in this co-extruded film, and the percentage listed in Table 1 is based on the whole film. The extruded film is subjected to a one-step stretching process on a commercial scale machine direction orientation machine below 90° C. to provide an oriented film containing voids. The stretching ratio is 5:1.

### B. Examples of Inventive Films and Comparative Films Treated by Heating/Pressure

Examples 1 to 13 of films are provided, in which Examples 1-8 are inventive examples (i.e., films containing voids before the heating/pressure treatment), and Examples 9-13 are comparative examples (i.e., being substantially free of voids before the heating/pressure treatment).

Particularly, Example 1 is a thermoplastic film (from Huangshan Novel Co., Ltd., Huangshan, Anhui province, China) comprising 51% of PE as the thermoplastic material and 49% of CaCO₃ as the void initiator, which is opaque as seen in FIG. 7 and contains a plurality of voids as seen in FIG. 8A. Examples 2-8 are films after heating/pressure treatment for the film of Example 1 under different parameters which are shown in the table below. Example 9 is a white, opaque PE-based film (from Huangshan Novel Co., Ltd.) containing TiO₂ particles, which is substantially free of voids. In the film of Example 9, TiO₂ particles have a different refractive index from that of PE and as such, light gets scattered when hitting TiO₂ particles, so that light is not able to pass through the film (i.e. opacity). Examples 10-13 are films after heating/pressure treatment for the film of Example 9 under different parameters. During the heating/pressure treatment, a clear PE film with a thickness of around 50 μm is used as a substrate to support the sample film and such clear PE film is transparent and does not contain voids. For Examples 1-5 and 9-13, the results for opacity and thickness are obtained in the presence of the clear PE film, while for Examples 6-8, results for opacity and thickness are obtained after the clear PE film is removed.

### C. Opacity Analysis

Absolute Opacity Value of Examples 1-13 are measured by the Method for Determining Opacity. As shown in the table below and in FIG. 7, the heating/pressure treatment significantly reduces the opacity of the films containing voids, and a certain degree of opacity can be achieved by controlling treatment parameters (for example, heating temperature, pressure and/or dwell time). As shown by the dashed line rectangles for Examples 5 and 8 in FIG. 7, when such treatment is applied on a part of the film of Example 1, it provides a thermoplastic film with selective opacity contrast (e.g., transparent or translucent windows in an opaque background).

TABLE 2
Treatment parameters and opacity of film examples

| | | | | | | |
|---|---|---|---|---|---|---|
| | | | | | Absolute | |
| Example | | Upper jaw | Pressure | Dwell time | Opacity | Thickness² |
| No. | Film type | Temp (° C.)¹ | (N/mm²) | (seconds) | Value | (μm) |

Films with void initiators

| | | | | | | |
|---|---|---|---|---|---|---|
| 1 | PE-CaCO₃ | — | — | — | 75.83% | 68.2 |
| | (no treatment) | | | | | |
| 2 | PE-CaCO₃ | 160 | 0.3 | 0.5 | 65.28% | 68.4 |
| 3 | PE-CaCO₃ | 160 | 1.5 | 1.5 | 14.23% | — |
| 4 | PE-CaCO₃ | 160 | 2.7 | 0.5 | 21.93% | 68.3 |
| 5 | PE-CaCO₃ | 160 | 2.7 | 2.0 | 14.66% | 65.9 |
| 6 | PE-CaCO₃ | 135 | 1.5 | 2.5 | 37.50% | 12.4 |
| 7 | PE-CaCO₃ | 135 | 1.5 | 2.0 | 47.42% | 14.2 |
| 8 | PE-CaCO₃ | 135 | 2.0 | 1.5 | 55.56% | 12.1 |

Comparative films without void initiators

| | | | | | | |
|---|---|---|---|---|---|---|
| 9 | White PE | — | — | — | 72.94% | 128 |
| | (no treatment) | | | | | |
| 10 | White PE | 160 | 0.3 | 0.5 | 72.67% | 133.8 |
| 11 | White PE | 160 | 1.5 | 1.5 | 71.56% | 130 |
| 12 | White PE | 160 | 2.7 | 0.5 | 71.19% | 128 |
| 13 | White PE | 160 | 2.7 | 2.0 | 71.04% | 131 |

¹Lower jaw temperature is 30° C.
²Thickness for Examples 6-8 does not include the substrate PE film.

### D. SEM Analysis

SEM images of the films of Examples 1, 5 and 8 in a cross-section along the machine direction are captured by Leica EM TIC 3X ion mill system with the cryogenic function. FIG. 8 shows these SEM images, in which A to C panels are respectively SEM images of Example 1 (before the treatment), Example 5 (after the treatment of 160° C./2.7 N/mm²/2 s) and Example 8 (after the treatment of 135° C./2.0 N/mm²/1.5 s), as recited in the above table. Under the condition of Example 5, the clear PE film used for sample preparation cannot be separated from the sample film because they are fused together, while under the conditions of Example 8, the PE film used for sample preparation are separated from the sample film before the SEM images are captured. As such, the bottom half of the SEM image in FIG. 8B is the cross section of the clear PE film. The images clearly show that voids are reduced or merged, at least partially, by the heating/pressure treatment. More particularly, under the medium heating/pressure conditions (for example, 135° C./2.0 N/mm²/1.5 s for Example 8), small voids are significantly reduced or eliminated, while large voids are left. Under the high heating/pressure conditions (for example, 160° C./2.7 N/mm²/2 s for Example 5), both small and large voids are significantly reduced. These data are perfectly consistent with the change of opacity from films before the treatment of heating/pressure to films after the treatment of heating/pressure, indicating the reduction/elimination of voids lead to the reduction of opacity of the films.

In order to characterize voids in the films according to the present disclosure, Void Area Percentage and Area Weighted Void Diameter are calculated by the Method for Voids Characterization, as shown in the following tables. Particularly, Void Area Percentage indicates the percentage of voids in the film, and Area Weighted Void Diameter indicates the size of voids in the film, particularly the diameter of voids (i.e., mean diameter). Without wishing to be bound by any theory, it is believed that these characterizations are related to the degree of opacity resulted from the presence of voids. Therefore, the present disclosure provides a method for preparing a film having different portions with different opacities by controlling characterizations of voids (for example, Void Area Percentage, Area Weighted Void Diameter) of the different portions in a heating/pressure process, and also provides films prepared by this method.

TABLE 3
Voids characterization of the film examples

| Example | Void Area | Area Weighted |
|---|---|---|
| No. | Percentage (%) | Void Diameter (nm) |
| 1 | 21 | 581 |
| 5 | 6 | 209 |
| 8 | 14 | 541 |

TABLE 4
Calculated results of Area Weighted Void Diameter of the film examples

| Example | | | Mean | Median | | 5% | 95% |
|---|---|---|---|---|---|---|---|
| No. | D_50/nm | D_90/nm | diameter/nm | diameter/nm | STD | size | size |
| 1 | 473 | 1169 | 581 | 475 | 404 | 65 | 1338 |
| 5 | 148 | 414 | 209 | 158 | 151 | 47 | 530 |
| 8 | 447 | 1064 | 541 | 462 | 374 | 65 | 1254 |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A thermoplastic film comprising at least one layer that comprises:
a) a first portion having a first Void Area Percentage and a first Absolute Opacity Value; and
b) a second portion having a second Void Area Percentage and a second Absolute Opacity Value, in which said second portion is adjacent to said first portion,
wherein the ratio between said first Void Area Percentage and said second Void Area Percentage is at least 1.05 in which Void Area Percentage is measured by the Method for Voids Characterization, and the difference between said first Absolute Opacity Value and said second Absolute Opacity Value is at least 5% in which Absolute Opacity Value is measured by the ISO6504-3 method,
wherein said layer comprises at least 20% by weight of the layer of a thermoplastic material selected from the group consisting of polyethylene (PE), polyamide (PA), polyethylene terephthalate (PET), polymethyl methacrylate (PMMA), polyurethane (PU), polyvinyl acetate (PVA), polyvinyl chloride (PVC), and any combinations thereof.

2. The thermoplastic film of claim 1, wherein the ratio between said first Void Area Percentage and said second Void Area Percentage is at least 1.1, preferably at least 1.2, more preferably at least 1.3, and/or the difference between said first Absolute Opacity Value and said second Absolute Opacity Value is at least 10%, preferably at least 15%, more preferably at least 20%,
preferably, wherein the ratio between said first Void Area Percentage and said second Void Area Percentage is from 1.05 to 100000, preferably from 1.1 to 1000, more preferably from 1.2 to 10, yet more preferably from 1.3 to 5, and most preferably from 2 to 4; and/or the difference between said first Absolute Opacity Value and said second Absolute Opacity Value is from 5% to 95%, preferably from 10% to 90%, more preferably from 15% to 80%, yet more preferably from 20% to 75%, and most preferably from 40% to 70%.

3. The thermoplastic film of claim 1,
wherein the ratio of said first Void Area Percentage over said second Void Area Percentage is at least 1.2, and/or said first Absolute Opacity Value is at least 10%, preferably at least 15%, more preferably at least 20% higher than said second Absolute Opacity Value.

4. The thermoplastic film of claim 1, wherein
said first Void Area Percentage is from 15% to 70%, preferably from 16% to 30%, more preferably from 17% to 25%; and/or
said first Absolute Opacity Value is from 50% to 99%, preferably from 60% to 98%, more preferably from 70% to 90%; and/or
said second Void Area Percentage is from 0.01% to 15%, preferably from 0.1% to 14%, more preferably from 1% to 10%; and/or
said second Absolute Opacity Value is from 1% to 65%, preferably from 5% to 50%, more preferably from 10% to 40%.

5. The thermoplastic film of claim 1, wherein:
said first portion has a first Area Weighted Void Diameter of from 350 nm to 8000 nm, preferably from 400 nm to 5000 nm, more preferably from 500 nm to 2000 nm in which Area Weighted Void Diameter is measured by the Method for Voids Characterization; and/or
said second portion has a second Area Weighted Void Diameter of from 8 nm to 350 nm, preferably from 10 nm to 320 nm, more preferably from 20 nm to 300 nm in which Area Weighted Void Diameter is measured by the Method for Voids Characterization.

6. The thermoplastic film of claim 1, wherein said layer comprises a heat-sealed region, wherein said second portion comprises at least one section that is not in said heat-sealed region.

7. The thermoplastic film of claim 1, wherein said layer is free of any heat-sealed region.

8. The thermoplastic film of claim 1, wherein said layer further comprises a void initiator, wherein the void initiator comprises an inorganic material with a refractive index of less than 2, preferably less than 1.9, more preferably less than 1.8, most preferably less than 1.7, and/or an organic material which is immiscible with the thermoplastic material;
wherein the inorganic material is selected from the group consisting of BaSO₄, lithopone, SiO₂, CaSiO₃, Al₂O₃, calcium carbonate, and any combinations thereof; and
wherein the organic material is selected from the group consisting of PA, PE, PET, PMMA, PS, PU, PVA, PVC, polypropylene (PP) and any combinations thereof.

9. The thermoplastic film of claim 8, wherein said layer comprises:
a) from 20% to 99%, preferably from 30% to 98%, more preferably from 35% to 65% by weight of the layer, of the thermoplastic material, which is PE; and
b) from 1% to 80%, preferably from 2% to 70%, more preferably from 35% to 65% by weight of the layer, of the void initiator, which is calcium carbonate and/or PMMA.

10. The thermoplastic film of claim 8, wherein said layer further comprises from 0.01% to 15%, preferably from 1% to 12%, more preferably from 2% to 10%, by weight of the layer, of an optional ingredient, which is selected from the group consisting of a silicone additive, a compatibilizer, and the combination thereof.

11. The thermoplastic film of claim 8, wherein said layer comprises no more than 1%, preferably no more than 0.5%, more preferably no more than 0.1%, yet more preferably no more than 0.05%, yet more preferably no more than 0.02%, yet more preferably no more than 0.01%, yet more preferably no more than 0.002%, most preferably no more than 0.001%, by weight of the layer, of TiO₂.

12. The thermoplastic film of claim 1, wherein said layer further comprises:
a third portion having a third Void Area Percentage and a third Absolute Opacity Value, in which said third portion is adjacent to said second portion, wherein the ratio of said third Void Area Percentage over said second Void Area Percentage is at least 1.05, and wherein said third Absolute Opacity Value is at least 5% higher than said second Absolute Opacity Value; and
optionally, a fourth portion having a fourth Void Area Percentage and a fourth Absolute Opacity Value, in which said fourth portion is adjacent to said third portion, wherein the ratio of said third Void Area Percentage over said fourth Void Area Percentage is at least 1.05, and wherein said third Absolute Opacity Value is at least 5% higher than said fourth Absolute Opacity Value.

13. The thermoplastic film of claim 1, wherein said film further comprises an additional layer which is bonded to said layer on either side of said layer, wherein said additional layer comprises at least 20%, by weight of the additional layer, of a thermoplastic material selected from the group consisting of PA, PE, PET, PMMA, PP, PU, PVA, PVC, and any combinations thereof.

14. The thermoplastic film of claim 1, wherein said film has a thickness of from 10 microns to 150 microns, preferably from 15 microns to 120 microns, more preferably from 20 microns to 100 microns, more preferably from 20 microns to 80 microns, and most preferably from 20 microns to 40 microns.

15. The thermoplastic film of claim 1,
wherein said first portion is opaque and said first Absolute Opacity Value is at least 70%, and optionally, said first Void Area Percentage is at least 50%; and
wherein said second portion is transparent or translucent and said second Absolute Opacity Value is no more than 30%, and optionally, said second Void Area Percentage is no more than 15%,
wherein said layer comprises:
a) from 35% to 65%, by weight of the layer, of PE; and
b) from 35% to 65%, by weight of the layer, of calcium carbonate.

16. A consumer product or packaged product comprising the thermoplastic film of claim 1, wherein the consumer product or packaged product is selected from the group consisting of a baby care product, a feminine care product, a laundry detergent product, a beauty care product, an adult incontinence product, a personal health care product, a paper product, a food product, and combinations thereof.

17. A method for preparing the thermoplastic film of claim 1, wherein the film comprises a first surface and a second, opposite surface, and the method comprises the step of applying heating and pressure treatment on the film using a heating-and-pressing device that comprises a first module contacting the first surface of the film and a second module contacting the second surface of the film, in which the heating-and-pressing device applies a pressure of from 0.1 N/mm² to 5 N/mm² for a duration of from 0.1 seconds to 10 seconds, and at least one of the first module and the second module has a contacting temperature of from 80° C. to 250° C.

18. The method of claim 17, wherein the first module has a contacting temperature of from 80° C. to 250° C., preferably from 120° C. to 200° C., more preferably from 130° C. to 180° C., and most preferably from 145° C. to 170° C., and the second module has a contacting temperature of from 15° C. to 80° C., preferably from 20° C. to 60° C., more preferably from 22° C. to 50° C., and/or wherein the pressure is from 0.3 N/mm² to 5 N/mm², preferably from 1 N/mm² to 4.5 N/mm², more preferably from 1.3 N/mm² to 4 N/mm², and most preferably from 2 N/mm² to 3 N/mm², and/or wherein the duration is from 0.2 seconds to 5 seconds, preferably from 0.3 seconds to 4 seconds, more preferably from 0.5 seconds to 3 seconds, and most preferably from 1 second to 2.5 seconds.

19. The method of claim 17, wherein the heating-and-pressing device is a machine press or a calender roll.
